(19) United States
(12) Patent Application Publication
(10) Pub. No.: US 2011/0034636 A1
(43) Pub. Date: Feb. 10, 2011

(54) Manipulating Surface Properties of Polymer with Migrating Additives

(76) Inventors: Lynden A. Archer, Ithaca, NY (US); Zhenyu Qian, Lemforde (DE)

Correspondence Address: HODGSON RUSS LLP;THE GUARANTY BUILDING, 140 PEARL STREET, SUITE 100, BUFFALO, NY, 14202-4040, US

(21) Appl. No.: 12/739,017

(22) PCT Filed: Oct. 22, 2008
(86) PCT No.: PCT/US08/11993

§ 371 Date: Oct. 12, 2010

Related U.S. Application Data
(60) Provisional application No. 60/960,929, filed on Oct. 22, 2007.

(51) Int. Cl. C08F 112/08; C08F 283/02

(52) U.S. Cl. 525/333.3; 525/464

(57) ABSTRACT

A method of obtaining a selected surface property and attribute in a host polymer or a blend of a host polymer with other polymers by blending the host polymer or polymer blend with from 0.1 to 10% by weight of a low molecular weight molecule additive (“additive”) chemically identical to the host polymer except for having one or more cores. The cores are chemically bonded to and provide anchor points for the branches which have optionally functionalized end groups. The optionally functionalized end groups, chemistry of the core, and/or physical form of the core impart properties to the surface of the host polymer or polymer blend. The invention also relates to a surface-modified polymer or polymer blend produced by the method.

The present application claims the benefit of U.S. Patent Application No. 60/960,929, the entirety of which is incorporated herein by reference.

This invention was made with U.S. Government Support at least under National Science Foundation Grants DMR0551185 and DMR0404278. The Government has certain rights in the invention.

### TECHNICAL FIELD

The invention is directed to manipulating the surface properties of a host polymer.

### BACKGROUND OF THE INVENTION

Polymer articles have been surface treated post-production to have selected surface properties. In these cases, the extra processing step adds substantially to the process costs, and the surface properties tend to change over time. While materials such as plasticizers, internal lubricants and fillers have been blended with host polymers, these materials perform their function by remaining well dispersed in the host material. Other materials such as surface tension modifiers, adhesion promoters, external lubricants and slip promoting agents, and biocompatibility enhancers are desired to localize at the surface of the polymer article.

Spontaneous migration of particular materials, for example, provide a simple, physical means of functionalizing polymer surfaces to enhance their paintability, wetability, and adhesion characteristics, without the need for post-processing (e.g. plasma or chemical treatment). Migration of low-surface-energy, non-polymeric materials in polymeric hosts is known. The mechanism can be understood in terms of the thermodynamic properties that the non-polymeric material imparts to the surface free energy of the polymeric host. These non-polymeric materials are typically small molecules having a structure distinct from that of the polymeric host so that the differences in thermodynamic properties between the non-polymeric material and polymeric host can be manipulated to modify the polymer. However, the impact of blending polymeric additives that are chemically identical or compatible with a polymer host was not sufficiently understood prior to the present invention to implement surface modifications thereof.

Methods for achieving selective partitioning of an additive to the bulk or enrichment to a polymer surface, as needed, are of considerable importance to the field.

### SUMMARY OF THE INVENTION

It has been discovered by the inventors of this application that additives can be incorporated into a host polymer or a polymer blend containing the host polymer and other polymer or polymers that are compatible with the host polymer to impart changed surface properties as a result of spontaneous surface segregation or because of flow induced migration. The additives are in the form of a low molecular weight branched molecule, which is chemically identical to or compatible with the host polymer and other polymer or polymers that are compatible with the host polymer, except for having a core and optional end groups.

In a first embodiment, the invention is directed to a method of obtaining a selected surface property and attribute in a host polymer or a blend of a host polymer with other polymer or polymers compatible with the host polymer (“host polymer blend”) comprising blending the host polymer or host polymer blend with from 0.1 to 10% by weight of a low molecular weight molecule additive (“additive”) chemically identical to or compatible with the host polymer or host polymer blend except for having one or more cores. The cores are chemically bonded to and provide anchor points for branches which have optionally functionalized end groups. The optionally functionalized end groups, chemistry of the core, and physical form of the core impart properties to the surface of the host polymer or host polymer blend.

In a second embodiment, the invention relates to a surface-modified polymer or surface modified polymer blend that may be produced by the first embodiment. The surface-modified polymer or surface-modified polymer blend, comprises a host polymer, or host polymer blend and from 0.1 to 10% by weight of an additive. The additive, comprises i) one or more cores, and ii) branches optionally having functionalized end groups, and wherein the additive is chemically identical to or compatible with the host polymer or host polymer blend, with the exception that the additive also comprises one or more cores chemically bonded to and that provide anchor points for the branches optionally having functionalized end groups. The core and optionally functionalized end groups impart a selected surface property and attribute of the host polymer or host polymer blend to obtain a surface-modified polymer or surface-modified polymer blend.

The term “blending” as recited herein includes, for example, melt blending, solution blending, extruding, mixing in a mutual solvent, and dispersion blending (mixing in a non-solvent).

The phrase “the order of magnitude” as recited herein means the critical molecular weight or degree of polymerization below a critical value can be estimated within a factor of ten.

A “low molecular weight molecule additive” as recited herein means a polymer having 2 to 30 repeating units, preferably 5-25 repeating units, and more preferably 10-20 repeating units and at least two branches. A low molecular weight additive has a molecular weight below 100,000 Da (g/mol), preferably between 50 Da to 100,000 Da, and more preferably between 25,000 Da to 750,000 Da.

A “compatible” polymer as recited herein means a polymer that forms a homogenous blend with another polymer without separating out.

A “star polymer” recited herein means a polymer with a special kind of chain architecture that is composed of several branched arms that are combined together through a single joint point or multiple joint points.

The term “hyper-branched polymer” recited herein means chain architectures with multiple branches jointed together in a compact but irregular way.

A term “dendrimer” recited herein means a type of star polymer having a chain architecture that is repeatedly branched, tree-like structure, usually with more than 3 generations.

The term “comb” recited herein means a type of star polymer having a chain architecture for a polymer with multiple branches equally distributed along a backbone.

The term “surface excess” recited herein means the difference between the surface concentration of additive to that in the bulk of the surface modified polymer or surface modified polymer blend.

The term “primary segment fraction” recited herein means the ratio of the total number of polymer segments or repeating units between chain ends and their nearest branch points to the total number of segments or repeating units in the molecule.

The term “surface lattice layer” recited herein means the position/distance of the additive relative to the surface of the surface modified polymer or surface modified polymer blend. A value of 0 indicates that the additive is on the surface itself.

### BRIEF DESCRIPTION OF THE DRAWINGS

FIG. 1 shows the surface excess of a variety of star-branched additives in a linear polymer host. Results are presented as a function of the primary segment fraction of the star.

FIGS. 2A, B, and C show a schematic providing a qualitative comparison of families of surface modified polymers. The greater than symbol indicates that the surface modified polymer with the structure to the left exhibits a greater surface modification.

FIG. 3 shows the surface tension for surface modified polymers.

FIG. 4 shows a large enrichment of additives at the surface of a surface modified polymer or surface modified polymer blend. The degree to which additives are enriched at the surface of the polymer increases as the branch or arm molecular weight is lowered.

FIG. 5 shows a star polymer having a nanoparticle or microparticle core.

FIG. 6 is a micrograph of a surface modified polymer.

FIG. 7 shows that migration of an additive to the surface of a surface modified polymer increases when the surface modified polymer is extruded.

### DETAILED DESCRIPTION

The first embodiment is directed to a method of obtaining a selected surface property and attribute in a host polymer, or host polymer blend. The method comprises blending the host polymer or host polymer blend with 0.1 to 10%, and preferably 2.0 to 8.0% by weight of a additive wherein the additive has i) one or more cores; and ii) two or more branches optionally having functionalized end groups.

The blending is preferably done by techniques such as melt blending, solution blending, mixing said host polymer or polymer blend with the additive in a mutual solvent, extruding, and dispersion blending.

The additive is chemically identical to, or compatible with the host polymer, with the exception that the additive comprises one or more cores chemically bonded to and that provide anchor points for the branches having optionally functionalized end groups. It is believed that the core and branches optionally having functionalized end groups impart the selected surface property and attribute of the host polymer or host polymer blend to obtain a surface-modified polymer or surface-modified polymer blend.

When the additive is identical to the host polymer, the branches are composed of the same polymer as the host polymer, with the exception that the additives have one or more cores and two or more branches optionally having functionalized end groups. The branches are optionally cross-linked or branched further by various chemical methods.

A compatible additive is an additive, wherein the branches are chemically different but are miscible with the host polymer. Additives that are compatible with the host polymer preferably have the same polymeric backbone as the host polymer but have different functional groups. The molecular weight of a compatible additive is below 10,000 Da, preferably less than 1,000, and more preferably from 50 Da to 1000 Da. When a compatible additive is incorporated into host polymer, the molecular weight of the host polymer is preferably above 10,000 Da, and preferably from between 10,000 Da to 100,000 Da.

The additives have at least two branches or arms. Additives can be produced, e.g., in the following ways: (1) direct synthesis of precursors followed by a linking step using silane, divinyl benzene, or other suitable linking/branching agent; (2) treatment of host polymer or a precursor material with a reactive, free-radical generating species; (3) radiation and/or electron beam treatment of host polymer; or (4) reactive extrusion of a polydisperse host polymer.

To impart surface selectivity, the critical molecular weight or degree of polymerization, N^{c}_{B}, of an additive can be estimated within an order of magnitude using the formula:

$${N}_{B}^{c} = - \frac{( {n}_{e} {U}_{B}^{e} + {n}_{j} {U}_{B}^{j} ) / Δ {U}_{B}^{s}}{1 - 2 {U}_{L}^{e} / ( {N}_{L} Δ {U}_{B}^{s} )} \qquad ( 1 )$$

wherein N_{L} is the degree of polymerization of the linear species, nₑ is the total number of ends, nⱼ is the number of branch points, defined as a point where more than two polymer segments meet, ΔU^{S}_{B} is the integrated strength of relative attraction of segments of branched species towards the surface, U^{e}_{B} and U^{j}_{B} represent the integrated strength of attraction of the end and branched point, respectively, of the branched polymer towards the surface, and U^{e}_{L} is the integrated strength of attraction of the ends of the linear host polymer ΔU^{S}_{B}, U^{e}_{B}, U^{e}_{L} and U^{j}_{B}, are measured in the units of length.

The additive can be selected from a multi-arm star, dendrimer, pom pom, stem flower, asymmetric, dumbbell, comb, randomly branched, or hyper-branched structure.

The star polymers have at least two branched arms that are combined together through a single joint point or multiple joint points. Star polymers having a single joint point generally have from 2-12 branches or arms, i.e., each branch is attached separately to various points on a single structure such as a core. The branches of star polymers having a single joint point do not exhibit cross-linking with each other, and do not possess secondary arms or branches. This does not exclude the presence of functionalized ends groups at the end of the branches. In a preferred embodiment, the star polymer having a single joint point is an 11-arm or branch star polymer.

Additive polystyrene star polymers having a single joint point with branch molecular weights in the range 100 Da to 50,000 Da, preferably 300 Da to 10,000 Da may be created using chlorosilane linking agents peroxide linking agents, electromagnetic radiation (e.g. x-rays, electron beams, ultraviolet), thiol linking agents, sulfur-based linking agents, polysaccharides, and nanostructures functionalized with reactive groups. The star polymers can then be blended with a linear host polymer, or a host polymer blend containing the linear host polymer. The molecular weights of the host polymer or host polymer blend may range from 100 Da to 30 million Da, and preferably 300 Da to 20 million Da.

Star polymers with multiple joint points exhibit additional branching at locations other than the core. For example, star polymers may have a first set of branches that attach to various points on a single structure, but also exhibit cross-linking between branches and/or include secondary branches that attach to the first set of branches. Examples of star polymers having multiple joint points are dendrimer and comb polymers.

Star polymers having multiple joint points include in situ generated hyper-branched structures produced by techniques such as peroxide based cross-linking, and radiation cross-linking.

The branches of the star polymers may vary in length. The inventors have found that the surface migration of the star polymer additives to the surface of a surface-modified polymer or surface-modified polymer blend can be manipulated by changing the symmetry of the star polymers. As the symmetry of the star increases, the migration of the additive to the surface of the surface-modified polymer or surface-modified polymer blend increases. In a preferred embodiment, 50%-100%, 72%-100%, and even more preferably 100% of the arms or branches of the star polymer are symmetrical with each other.

Examples of functionalized branch ends are nitroxy, alkene, alkyne, epoxy, ethylene oxide, chloride, bromide, amine, sulfonic acid, hydroxyl carboxyl, anhydride, fluorine, or siloxane. The functions provide the following properties: carboxyl, nitroxy, alkene, alkyne, epoxy, and anhydride provide adhesion and paintability property; hydroxyl and sulfonic acid provides a hydrophility property; alkyl and fluorine provides hydrophobicity; ethylene oxide, siloxane, alkyl, and fluorine also provide antistick properties, including retardation of protein, DNA, and polysaccharide adsorption; siloxane provides external lubrication and shark-skin suppression; amine provides antistatic and paintability properties; and bromide and chloride provide flame retardance.

The functionalized branch end groups can be added to the arms or branches of the additives by using a terminator. One skilled in the art would select the terminator based on the functional group that needed to be added to the end of the branch. For example, an alkyl silane terminator having one or more fluorine, bromine, amine, or hydroxyl groups would be selected to, respectively, impart fluorine, bromine, amine, or hydroxyl functionality at the end of the branch. Likewise, epichlorohydrin or carbon dioxide can be used to impart epoxy or carboxyl functionality.

Examples of cores for the additives are molecules or particles with multifunctional groups including chlorosilanes for providing a star polymer, a block polymer compatible with a host polymer, a block polymer not compatible with a host polymer, a randomly linked polymer, silica, tin dioxide, titania, cobalt oxide, iron oxide, alumina, hafnia, ceria, copper oxide, gold to provide surface reflectivity, silver to provide anti-microbial activity; clay or silica to provide enhanced abrasive/scratch resistance; and nanoparticles.

A nanoparticle is a small object that behaves as a whole unit in terms of its transport and properties. Nanoparticles generally measure in one dimension between 1-100 nanometers (nm). Nanoparticles have a very high surface area to volume ratio. Extensive libraries of nanoparticles, composed of an assortment of different sizes, shapes, and materials, and with various chemical and surface properties, have been constructed. A variety of nanoparticles can be used as cores, including multi-lobed nanoparticles, conductive nanoparticles, hollow nanoparticles, fullerenes such as buckyballs and carbon tubes, liposomes, nanoshells, dendrimers, quantum dots, nanocrystals, magnetic nanoparticles, metal nanoparticles, and nanorods.

Surface functionality can be obtained by spontaneous surface segregation without imparting any migration stimulus, e.g., flow induced transport/diffusion induced by forcing admixture with a piston through a die, e.g., using an extruder, and extrusion of host polymer spray coated with a additive.

In a preferred embodiment, surface functionality is enhanced by extruding the additive admixed with host polymer or host polymer blend. The additive and host polymer or host polymer blend may be extruded at temperatures ranging from 140° C. to 200° C., preferably 150° C. to 170° C. in an extruder.

We now turn to the second embodiment of the invention, which is directed to a surface-modified polymer or surface-modified polymer blend produced by the method of the first embodiment. The surface-modified polymer or surface-modified polymer blend, comprises a host polymer, or a host polymer blend, wherein said host polymer, or host polymer blend with 0.1 to 10% by weight of an additive.

The additive comprises i) one or more cores; and ii) branches optionally having functionalized end groups. The additive is chemically identical or compatible with, the host polymer with the exception that the additive comprises one or more cores chemically bonded to and that provide anchor points for the branches. The branches themselves optionally have functionalized end groups. The core and branches having the functionalized end groups impart the selected surface property and attribute to the host polymer or host polymer blend to provide a surface-modified polymer or surface-modified polymer blend.

The additives, cores, functionalized end groups, branches, surface selectivity, surface functionality, and other features of the surface-modified polymer or surface-modified polymer blend are in accordance with those described for the first embodiment as discussed above.

The surface-modified polymers or surface-modified polymer blends include polymers such as polystyrene host polymers with a carboxyl functionalized star additive to provide surface paintability; polycarbonate host polymers with a polycarbonate star additive containing liquid silica nanoparticle core to provide scratch resistance, polystyrene host polymers with poly(benzyl ether) dendrimer additive to increase the wetability on silicon surface, desalination membrane host polymer comprising polyacrylonitrile-graft-poly (ethylene oxide) with polyacrylonitrile-graft-poly (ethylene oxide) comb copolymer additive to increase the anti-fouling ability, ultrafiltration membrane comprising polyacrylonitrile-graft-poly (ethylene oxide) host polymer with polyacrylonitrile-graft-poly (ethylene oxide) comb copolymer additive to increase the anti-fouling ability, a polypropylene host polymer with a polystyrene additive to impart styrenic functionality on the surface, a polyvinyl alcohol host polymer with a polyethylene additive to impart polyethylenic functionality on the surface properties, a polyethylene host polymer with a polypropylene additive to impart propylenic functionality on the surface, polymethacrylate host polymer with a polystyrene additive to impart styrenic functionality on the surface, a polyvinyl chloride host polymer with a polystyrene additive to impart styrenic functionality on the surface, and linear polyester hosts with hyperbranched polyester additive to modify the surface tension.

In a preferred embodiment, the host polymer is a polycarbonate material such as a poly (bisphenol-A carbonate)-based material, or a polycarbonate material obtained by reacting potassium carbonate with a dibromo derivative of benzene. The additive comprises i) one or more cores; and ii) branches optionally having functionalized end groups as discussed above. The additive is chemically identical or compatible with the polycarbonate host polymer, with the exception that the additive comprises one or more cores chemically bonded to and that provide anchor points for the branches. The branches themselves optionally have functionalized end groups as discussed above.

Additives with cores of metal oxide such as alumina, titania, and iron oxide are preferred. Because of the preponderance of metal oxide core particles imparted by surface migration of such additives, the surface-modified polycarbonate will exhibit enhancements in scratch, solvent, and crazing resistance.

Background and working example for the invention are set forth below.

### Background Example 1

Several models and simulations were used by the inventors to help determine the features of the additives and host polymers that can be utilized to provide a surface modified polymer or surface modified polymer blend as discussed above. In particular, the inventors studied entropy-driven segregation of various additives in chemically similar linear polymer hosts with a self-consistent (SCF) mean-field lattice simulation model as disclosed by Fleer, G. J.; Cohen Stuart, M. A.; Scheutjens, J. M. H. M.; Cosgrove, T.; Vincent, B. Polymers at Interfaces 1993, Chapman and Hill, London and as discussed by Minnikanti, V. S.; Archer, L. A. J Chem Phys 2005, 123, 144902; Minnikanti, V. S.; Archer, L. A. J Chem Phys 2005, 122, 084904; and Minnikanti, V. S.; Archer, L. A. Macromolecules 2006, 39, 7718-7728.

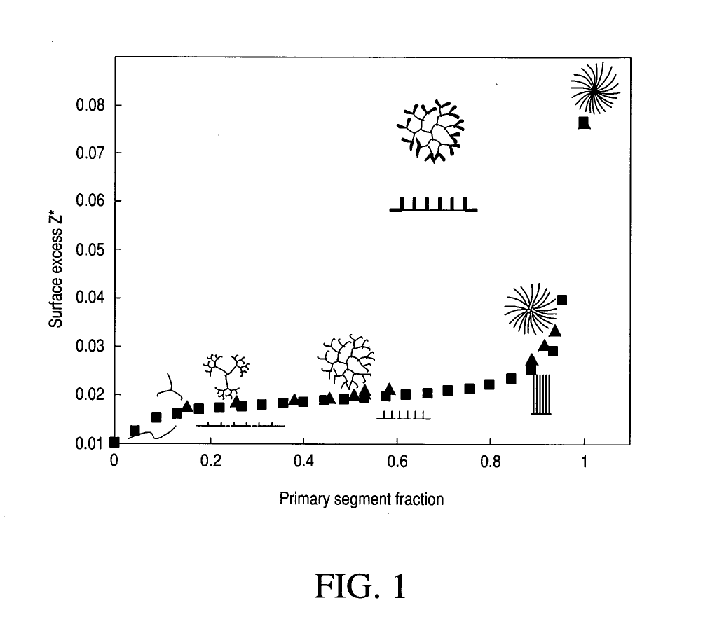

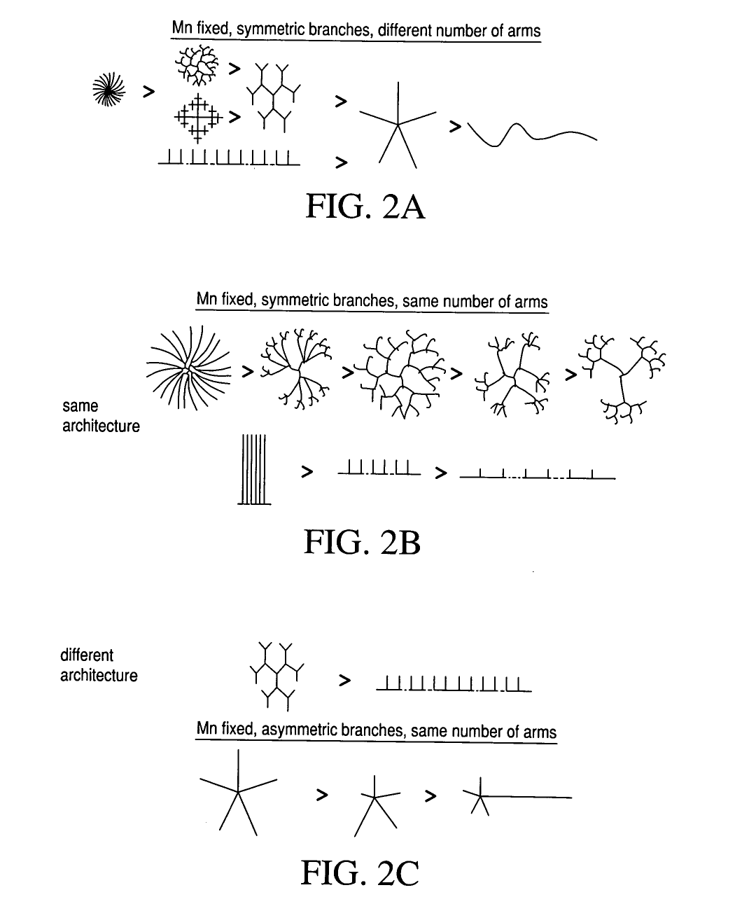

The SCF mean-field lattice simulation shows that star, dendrimer, and comb-like additives enrich the surface of chemically identical linear host polymers. The inventors also found that the symmetry of the polymer also effects the surface excess of the polymer. FIG. 1 shows the surface excess of surface modified polymers. The migration of the additive to the surface of the surface-modified polymer or surface-modified polymer blend increases as the number of arms or branches increases. The migration of the additive to the surface of the surface-modified polymer or surface-modified polymer blend also increases as the symmetry of the branches of the additive increases. FIGS. 2A, B, and C are a schematic providing a qualitative comparison of families of surface modified polymers. The greater than symbol indicates that the surface modified polymer with the structure to the left exhibits a greater surface modification.

### Background Example 2

Star-branched 4-arm and 11-arm polystyrene star polymers with arm/branch molecular weights in the range 300 g/mol to 10000 g/mol were created using multifunctional chlorosilane linking agents to provide a core and blended with a linear polystyrene host with molecular weights in the range of 300 g/mol to 20 million Da. A combination of melt blending in a hand mixer and solution blending in a solvent for polystyrene were used to create homogeneous blends of the materials. Benzene was used as the solvent but other solvents such as toluene, teterahydrofuran, chloroform, dichloromethane, and N,N-dimethylformamide may be used. After mixing, blends were gently heated in vacuum to remove any air bubbles or solvent and annealed at temperature of 160° C. Blends of linear polystyrene additives of comparable molecular weight of the stars dispersed in the same linear hosts were created using the same approach.

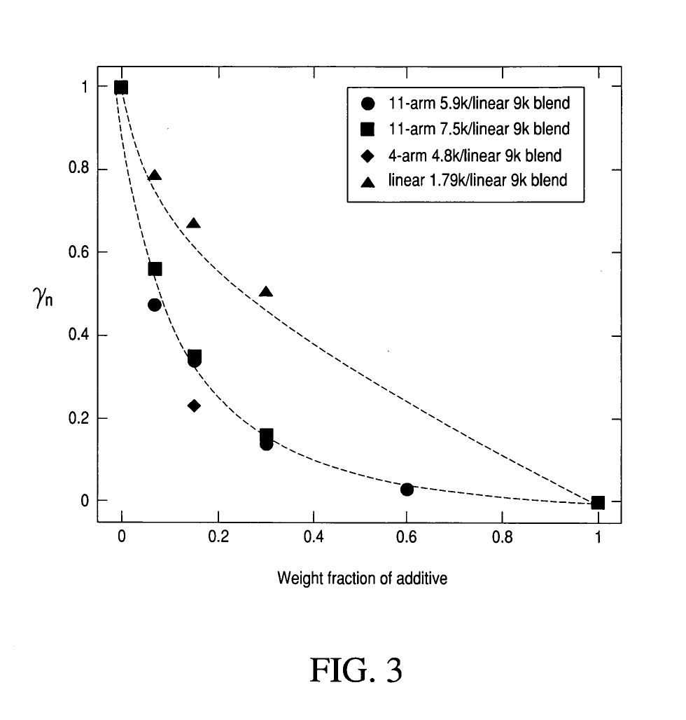

Two procedures were used to characterize the surface migration of the additive star polystyrene. In the first approach, the surface tension of a 10 ml sample of the blend was characterized using a Wilhelmy fiber method. The Wilhelmy fiber method is currently the most sensitive method for characterizing surface tension of polymer melts. FIG. 3 shows a representative set of surface tension data obtained by blending various 11-arm, 4-arm, and linear polystyrenes in a chemically similar linear host polystyrene with a fixed molecular weight of 9,000 g/mol. The figure plots the normalized surface tension, (γₙ=(γ−γ₁)/(γ₂γ₁)) as a function of the weight fraction of additive in the polymer host. Here the subscripts 1 and 2 refer to the additive, and linear host polymer, respectively, and γ is the surface tension of the blend. Based on this definition γₙ takes a value of 1 for the pure host and a value of 0 for the pure additive. Changes in γₙ produced either by changing the additive architecture reflects changes in the surface composition of the host polymer/additive mixture. The filled circles in FIG. 3 are results for a 11-arm star/branch with an overall molecular weight of 5,900 Da; squares are for a 11-arm star/branch additive with an overall molecular weight of 7,500 Da; diamonds are for a 4-star/branch star additive with molecular weight of 4,800 Da; triangles for a linear additive with molecular weight of 1,790 Da.

FIG. 3 shows that the surface tension of the blend is not a linear function of the additive composition in the mixture. Rather, a non-linear relationship exists, with the most highly branched stars with the lowest arm molecular weights exhibiting the most migration to the surface the surface of the polymer. This observation means that the stars are strongly enriched at the surface.

Only a small amount of star branched additive is required to saturate the surface of the host material. Specifically, FIG. 3 shows that even at a weight fraction of additive of around 5%, the surface tension of the blend is substantially lower than the host polymer and is indeed closer to that of the additive. This finding means that the additive can be used to functionalize the surface chemistry of a surface modified polymer or surface modified polymer blend.

A more direct approach for characterizing the surface composition of these blends is to use Dynamic Secondary Ion Mass Spectrometry (DSIMS). In this approach a solution blend of the host polymer and additive is coated on a glass disc or silicon wafer to produce a thin film of the blend. A high-power laser is used to ablate/etch away the film layer-by-layer and the chemical composition of the ablated material in each layer characterized using a mass spectrometer. Provided there is chemical contrast between an additive and host polymer, DSIMS allows both the surface composition and composition profile of the additive to be directly characterized.

To create chemical contrast for the DSIMS measurements deuterated polystyrene was used as a host polymer and polystyrene stars were used as additives. Table 1 summarizes properties of a small subset of the star-branched additives used.

TABLE 1
Representative 11-arm polystyrene stars used for
DSIMS characterization of dPS/PS blend surfaces

| | M_{wa} [g/mol] | M_{w} [g/mol] | M_{w}/Mₙ | f | T_{g} [° C.] |
|---|---|---|---|---|---|
| R33 | 510 | 5900 | 1.03 | 10.6 | 64 |
| R34 | 660 | 7500 | 1.03 | 10.6 | 69 |
| R35 | 760 | 8800 | 1.03 | 10.9 | 73.5 |
| R36 | 1400 | 15800 | 1.04 | 10.9 | 81.5 |
| R37 | 2680 | 29000 | 1.04 | 10.6 | 92 |
| R38 | 5400 | 59000^{b} | 1.03 | 10.8 | 100.5 |

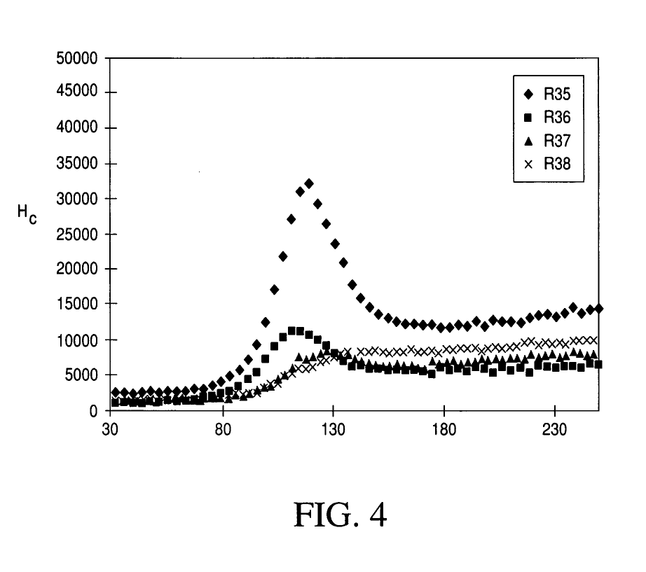

Table 1 summarizes the arm molecular weight, M_{wa}, overall polymer molecular weight M_{w}, polydispersity index M_{W}/Mₙ, number of arms per branch f, and glass transition temperature T_{g} of the pure stars. In one experiment these star additives were blended at a fixed weight fraction of 10% in a linear deuterated polystyrene of molecular weight 10,000 g/mol using the solution blending procedure outlined earlier. Because deuterated styrene has a lower surface energy than normal hydrogenated styrene, the surface composition of the host polymer would be expected to be higher. Raw DSIMS data for the materials is presented in FIG. 4. This data shows a large enrichment of the hydrogenated species, Hc, at the surface and that the degree to which the stars are enriched increases as the arm/branch molecular weight is lowered.

The following working examples illustrate the invention as follows:

### Example I

One way of synthesizing star additives with carboxyl end functionalization is through a “core” first anionic polymerization procedure. The operations and the procedures are quite similar to those details in Background Example 3 except that a multifunctional organolithium initiator is made in advance. This is described in the literature (see Lee J S, Quirk R P, Foster M D, MACROMOLECULES, 38, 5381-5392, 2005). This kind of initiator is used to initiate anionic polymerization of styrene or isoprene to form a living star architecture with all the lithium ion living sites at the end of the branch. Instead of using degassed isopropanol or methanol as terminators, ultra pure carbon dioxide gas is purged into the reaction system for several hours so that a star polymer with carboxyl end-functionalized groups is made. This kind of potential functionalized additive is then melt or solvent blended with its linear styrene or isoprene counterparts. The additive is added in an amount of 5% by weight of the linear styrene or isoprene polymer host. In quiescent state, the surface energy difference between the additives and the polymer host or polymer blend allows the additives to migrate toward the surface of the polymer. The existence of the carboxyl group at the surface enhances the paintability of the polymer composite.

### Example II

Polyethylene glycol/oxide (PEG, PEO) and Polstyrene (PS) additives having triethoxysilyl group at one end of the chain are reacted with the hydroxyl group on the surface of bare metal oxide particle of alumina, including alumina, cobalt oxide, iron oxide, silica, titania, tin dioxide in an organic solvent such as toluene, or in polar solvents such as water that (for hydrophobic polymers such as styrene) a surfactant additive such as TWEEN or Sodium dodecyl sulfate SDS is included. Fractionation with toluene/methanol is then carried out to obtain nearly pure PEG/PEO and PS additives. As an alternative to this scheme, the metal oxide particles are first functionalized with a molecular species containing polymerizable, or cross-linkable groups (e.g. vinyl groups). The “pre-functionalized” particles are then introduced to a vessel containing additives containing reactive groups (e.g. alkyl lithium), which react with the functionalized particles forming covalent bonds. A variety of analytical tools e.g. GPC, TGA, and MALDI TOF are used to determine the functionality of the branches, that is, the number of oligomer branches. The resultant star-shaped PEG/PEO additives have a polymer volume fraction below 50%, form neat, solvent-free liquids at room temperature. The star-shaped PS materials are glasses, but undergo a glass transition to a liquid state at a temperature near 50° C., i.e. substantially lower than for a linear PS molecule. Addition of 5.0% by weight of these particle-centered stars by melt/solvent blending with a high molecular weight PEO/PS matrix is employed to produce a coating of hard particles at the polymer surface.

### Example III

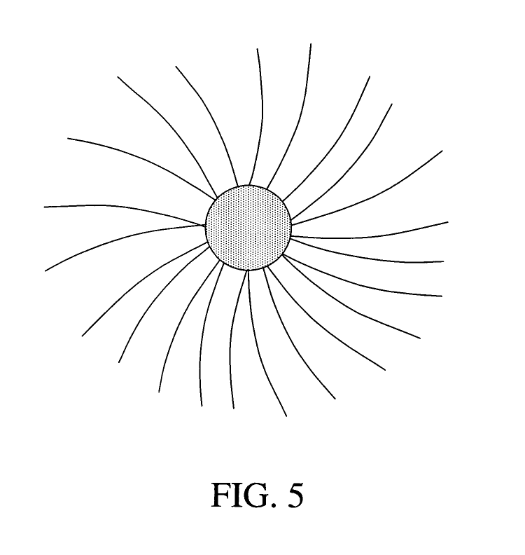

A polystyrene-based silica Nanoparticle Organic Hybrid Materials (NOHMS) as represented in FIG. 5 is produced by covalently grafting amine or epoxy terminated polystyrene with molecular weights in the range 300 g/mol to 50,000 Da to the surface of silane functionalized silica nanoparticles with diameters ranging from 250 nm to 7 nm. By thermal gravimetric analysis, it is determined that the number of polymer molecules per unit area of surface range from 0.1 to 4, with the best results (i.e., highest grafting densities) achieved for polymers with molecular weights below 5000 Da.

To explore surface segregation of the cores, PS NOHMS are blended with linear polystyrene hosts with molecular weights in the range 300 g/mol to 20 million g/mol. A combination of melt blending in a hand mixer and solution blending in a solvent for polystyrene is used to create homogeneous blends of the materials. Benzene is used as the solvent but other solvents such as toluene, teterahydrofuran, chloroform, dichloromethane, and N,N-dimethylformamide may also be used. After mixing, blends are gently heated in vacuum to remove any air bubbles or solvent and are annealed at a temperature 160° C. in an inert environment.

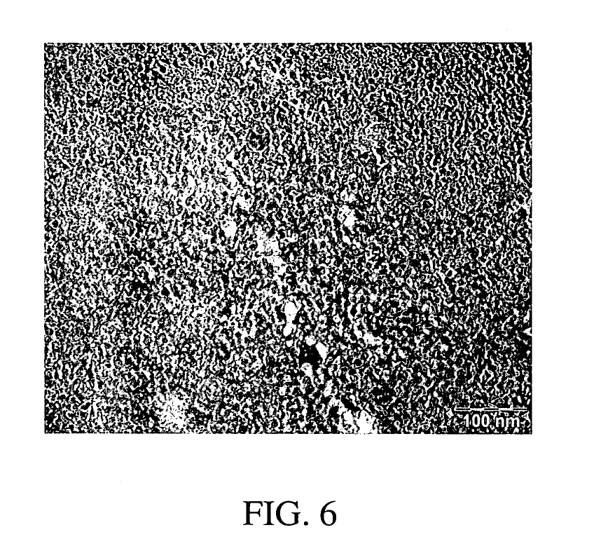

The surfaces of the blends are characterized using scanning electron microscopy and DSIMS. FIG. 6 illustrates a typical SEM micrograph for a mixture of a host polystyrene with a molecular weight of 53,000 Da and a NOHMS having 10-15 nm SiO₂ nanospheres grafted with polystyrene with a molecular weight of 1,500 Da. In this case, the blend is a 5 wt % mixture of the NOHMS additive in the host polymer. The SEM micrograph shows that surface of the mixture is saturated with the nanoparticle cores. It also shows that the nanoparticle cores remain as discrete entities on the surface and do not aggregate. This observation is confirmed by DSIMS, which shows a large enhancement in the concentration of Si at the surface, consistent with an enrichment of the SiO₂ cores. The small sizes, higher modulus, and greater hardness of SiO₂ NOHMS core particles exhibit several beneficial characteristics for the polymer surface. For example, particles are small enough that they do not scatter light and preserve the optical clarity of the host polymer. The hard cores enhance the ability of the polymer surface to resist scratching. The mechanical reinforcement provided by the silica cores also enhance the modulus of the polymer surface, having an increased resistance to solvent penetration, crazing, and crack propagation.

### Example IV

A poly (bisphenol-A carbonate)-based silica NOHMS is produced in a manner similar to Example III. Specifically, polymers based on 2-2′-bis(4-hydroxyphenyl) propane (bisphenol A) with molecular weights in the range 770 Da to 26,000 Da are synthesized by reacting the dihdyric phenol with phosgene in dry prydine. Terminal alcohol groups are reacted with epichlorohydrin in the presence of NaOH, epoxy functionality are introduced to the polycarbonate.

Alternatively, by reacting the poly (bisphenol-A carbonate)-based silica NOHMS with a cyclic sulfonate or anhydride (e.g. succinic anhydride), sulfonic acid or carboxylic acid, functionality is introduced by ring opening. Poly (bisphenol-A carbonate) with any of these functionalities are reacted with amine groups tethered to the surface of nanoparticles (e.g. silica) to produce poly (bisphenol-A carbonate)-based silica NOHMS.

A metal oxide is added (e.g. alumina, titania, iron oxide) to the poly (bisphenol-A carbonate)-based NOHMS in and amounts equal to or less than 5% by weight in a poly (bisphenol-A carbonate) host polymer with a degree of polymerization greater than the critical value deduced from equation (1), the same mechanism identified in Example III causes hybrid particles to segregate to the surface of their host, imparting scratch resistance.

Melt blending in a twin screw extruder at a temperature above 270° C. is further used to mix the polycarbonate host and NOHMS additive. After mixing, blends are heated in vacuum to remove any air bubbles or solvent and annealed at temperatures above 270° C. in an inert environment and provides a surface-modified polycarbonate.

The surface-modified polycarbonate exhibits enhancements in scratch, solvent, and crazing resistance due to the preponderance of metal oxide core particles imparted by surface migration of the NOHMS additive.

### Example V

The levels of surface enrichment with branched, linear, or nanoparticle hybrid additives is enhanced by using stress fields employed in polymer shaping operations such as extrusion. Narrow molecular weight distribution (MWD) polystyrenes with a wide range of molecular weights and long-chain branch polyethylenes with a range of melt indices are used with broad MWD polyethylene-co-methacrylic acid (PE-co-MA) and narrow MWD polystyrene-co-dimethyl siloxane (PS-co-PDMS) copolymer additives. PE-co-MA copolymers in the study contain 10% methacrylic acid (MA) and possess a melt flow index of 500 g/min. at 190° C. The maleic anhydride groups impart paintability to the surface modified polymer. As such, their presence at the host PE surface is desirable.

PE/PE-co-MA blends containing 10% copolymer additive (90/10 PE/PE-co-MA) are prepared by solution casting and/or melt mixing with a twin screw extruder. Solution cast films are prepared by dissolving polymer components in the required proportions in xylene at 120° C. (2 wt % polymer in solution). Subsequent evaporation of the xylene at 40° C. in aluminum pans yield sample films with a controlled thickness in the range of 40-50 mm. As to the solution preparation conditions, xylene is a good solvent for both PE and PE-co-MA. Selective surface enrichment due to differential miscibility of the polymer components is minimized during film casting. Remaining traces of solvent are removed in a final vacuum evaporation step at room temperature.

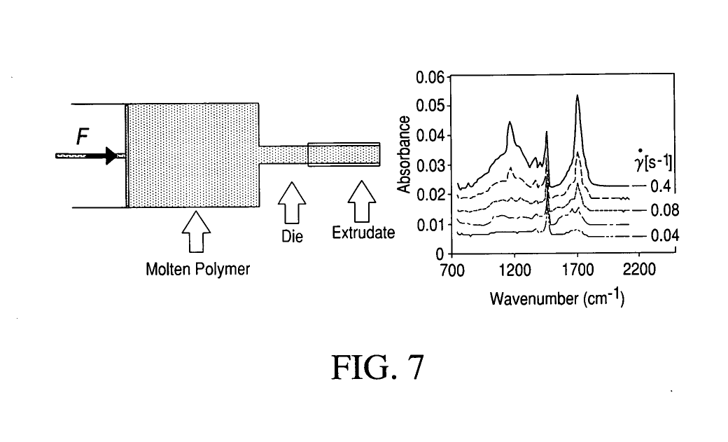

Blends of the two polymers are extruded at a temperature of 160° C. in a simple hydraulic driven capillary extruder at various nominal shear rates (0.004 s⁻¹, 0.008 s⁻¹, and 0.4 s⁻¹), illustrated in FIG. 7. The extruder is outfitted with custom fabricated stainless steel slit dyes (L/H 5 to 10000). The surface composition of the extrudate is characterized using attenuated total reflection Fourier transform Infrared Spectroscopy (ATR-FTIR). The right panel in FIG. 7 shows the ATR-FTIR spectra obtained at various flow rates of the PE/PE-co-MA blends. The carbonyl peak at ca 1680 cm⁻¹ is a characteristic of the PE-co-MA additive.

It is apparent from the figure that not only is the composition of the additive at the extrudate surface increased by extrusion, but that the effect is in fact quite large. A similar observation was made for the PS/PS-co-PDMS blends; however in that case even in the absence of extrusion the surface composition of the PS-co-PDMS additive is already quite large.

What is claimed is:

1. A method of obtaining a selected surface property and attribute in a host polymer, or a polymer blend containing the host polymer and at least one other polymer compatible with the host polymer, comprising the steps of:
blending the host polymer or polymer blend with 0.1 to 10% by weight of a low molecular weight molecule additive (“additive'), wherein said additive comprises:
i) one or more cores; and
ii) branches optionally having functionalized end groups;
wherein said additive is chemically identical to, or compatible with, the host polymer with the exception that said additive comprises one or more cores chemically bonded to and that provide anchor points for the branches having optionally functionalized end groups, and
wherein the core and optional functionalized end groups impart the selected surface property and attribute to the host polymer or polymer blend to obtain a surface-modified polymer or surface-modified polymer blend.

2. The method according to claim 1, wherein the step of blending is selected from the group consisting of melt blending, solution blending, mixing said host polymer or polymer blend with said additive in a mutual solvent, and dispersion blending.

3. The method according to claim 1, wherein the additive is selected from the group consisting of a multi-arm star, dendrimer, pom pom, stem flower, asymmetric, dumbbell, comb, randomly branched, and hyper-branched structure.

4. The method according to claim 3, wherein the additive has at least two branches or arms.

5. The method according to claim 1, wherein the additive has an overall molecular weight or degree of polymerization below a critical value of the order of N^{c}_{B}, which can be estimated within an order of magnitude using the following formula:
$${N}_{B}^{c} = - \frac{( {n}_{e} {U}_{B}^{e} + {n}_{j} {U}_{B}^{j} ) / Δ {U}_{B}^{s}}{1 - 2 {U}_{L}^{e} / ( {N}_{L} Δ {U}_{B}^{s} )} \qquad ( 1 )$$
wherein
N_{L} is the degree of polymerization of the linear species, nₑ is the total number of ends possessed by the additive, nⱼ is the number of branch points, defined as a point where more than two polymer segments meet, ΔU^{S}_{B} is the integrated strength of relative attraction of segments of branched species towards the surface, U^{e}_{g} and U^{j}_{B} are the integrated strength of attraction of the end and branched point, respectively, of the branched polymer towards the surface,
U^{e}_{L} is the integrated strength of attraction of the ends of the linear host polymer ΔU^{S}_{B}, wherein U^{e}_{B}, U^{e}_{L} and U^{j}_{B}, are measured in the units of length and reflect entropic changes, energetic changes, and density changes arising from the branched architecture of the oligomer.

6. The method according to claim 1, wherein the additive has a functionalized branched end group selected from the group consisting of carboxyl, anhydride, nitroxy, alkene, alkyne, epoxy, fluorine, chloride, bromide, siloxane, amine, sulfonic acid, and hydroxyl.

7. The method according to claim 1, wherein the one or more cores are molecules or nanoparticles with multifunctional groups selected from the group consisting of chlorosilanes, block polymers compatible with a host polymer, block polymers not compatible with a host polymer, a randomly linked polymer, silica, tin dioxide, titania, cobalt oxide, iron oxide, alumina, hafnia, ceria, copper oxide, gold, and silver.

8. The method according to claim 1, wherein the surface-modified polymer or surface-modified polymer blend is a polymer selected from the group consisting of a polystyrene host polymer with a carboxyl functionalized star additive, polycarbonate host polymer with polycarbonate star additive containing a liquid silica nanoparticle core, a polystyrene host polymer with poly(benzyl ether) dendrimer additives, desalination membrane host polymer comprising polyacrylonitrile-graft-poly (ethylene oxide) with polyacrylonitrile-graft-poly (ethylene oxide) comb copolymer additive to increase the anti-fouling ability, ultrafiltration membrane comprising polyacrylonitrile-graft-poly (ethylene oxide) host polymer with polyacrylonitrile-graft-poly (ethylene oxide) comb copolymer additive to increase the anti-fouling ability, a polypropylene host polymer with a polystyrene additive to impart styrenic functionality on the surface, a polyvinyl alcohol host polymer with a polyethylene additive to impart polyethylenic functionality on the surface properties, a polyethylene host polymer with a polypropylene additive to impart propylenic functionality on the surface, polymethacrylate host polymer with a polystyrene additive to impart styrenic functionality on the surface, a polyvinyl chloride host polymer with a polystyrene additive to impart styrenic functionality on the surface, and a linear polyester host polymer with hyperbranched polyester additives.

9. A surface-modified polymer or surface-modified polymer blend obtained by the method according to claim 1.

10. A surface-modified polymer or surface-modified polymer blend, comprising:
a host polymer, or a polymer blend containing the host polymer and at least one other polymer compatible with the host polymer, wherein said host polymer, or polymer blend with 0.1 to 10% by weight of a additive, said low molecular weight molecule additive (“additive”), comprising:
i) one or more cores; and
ii) branches optionally having functionalized end groups;
wherein said additive is chemically identical to or compatible with, the host polymer with the exception that said additive comprises one or more cores chemically bonded to and that provide anchor points for the branches optionally having functionalized end groups, and
wherein the core and optional functionalized end groups impart the selected surface property and attribute to the host polymer or polymer blend to obtain a surface-modified polymer or surface-modified polymer blend.

11. The surface-modified polymer or surface-modified polymer blend according to claim 10, wherein the additive is selected from the group consisting of a multi-arm star, dendrimer, pom pom, stem flower, asymmetric, dumbbell, comb, randomly branched, and hyper-branched structure.

12. The surface-modified polymer or surface-modified polymer blend according to claim 11, wherein the additive has at least two branches or arms.

13. The surface-modified polymer or surface-modified polymer blend according to claim 10, wherein the additive has an overall molecular weight or degree of polymerization below a critical value of the order of, N^{c}_{B}, which can be estimated using the following formula:
$${N}_{B}^{c} = - \frac{( {n}_{e} {U}_{B}^{e} + {n}_{j} {U}_{B}^{j} ) / Δ {U}_{B}^{s}}{1 - 2 {U}_{L}^{e} / ( {N}_{L} Δ {U}_{B}^{s} )} \qquad ( 1 )$$
wherein
N_{L} is the degree of polymerization of the linear species, nₑ is the total number of ends possessed by the additive, nⱼ is the number of branch points, defined as a point where more than two polymer segments meet, ΔU^{S}_{B} is the integrated strength of relative attraction of segments of branched species towards the surface, U^{e}_{B} and U^{j}_{B} are the integrated strength of attraction of the end and branched point, respectively, of the branched polymer towards the surface,
U^{e}_{L} is the integrated strength of attraction of the ends of the linear host polymer ΔU^{S}_{B}, wherein U^{e}_{B}, U^{e}_{L} and U^{j}_{B}, are measured in the units of length and reflect entropic changes, energetic changes, and density changes arising from the branched architecture of the oligomer.

14. The surface-modified polymer or surface-modified polymer blend according to claim 10, wherein the additive has a functionalized branched end group selected from the group consisting of carboxyl, anhydride, nitroxy, alkene, alkyne, epoxy, fluorine, chloride, bromide, siloxane, amine, sulfonic acid, and hydroxyl.

15. The surface-modified polymer or surface-modified polymer blend according to claim 10, wherein the one or more cores are molecules or nanoparticles with multifunctional groups selected from the group consisting of chlorosilanes, block polymers, compatible with a host polymer, block polymer not compatible with a host polymer, a randomly linked polymer, silica, tin dioxide, titania, cobalt oxide, iron oxide, alumina, hafnia, ceria, copper oxide, gold, and silver.

16. The surface-modified polymer or surface-modified polymer blend according to claim 10, wherein the surface-modified polymer or surface-modified polymer blend is a polymer selected from the group consisting of a polystyrene host polymer with a carboxyl functionalized star additive, polycarbonate host polymer with polycarbonate star additive containing a liquid silica nanoparticle core, a polystyrene host polymer with poly(benzyl ether) dendrimer additives, desalination membrane host polymer comprising polyacrylonitrile-graft-poly (ethylene oxide) with polyacrylonitrile-graft-poly (ethylene oxide) comb copolymer additive to increase the anti-fouling ability, ultrafiltration membrane comprising polyacrylonitrile-graft-poly (ethylene oxide) host polymer with polyacrylonitrile-graft-poly (ethylene oxide) comb copolymer additive to increase the anti-fouling ability, a polypropylene host polymer with a polystyrene additive to impart styrenic functionality on the surface, a polyvinyl alcohol host polymer with a polyethylene additive to impart polyethylenic functionality on the surface properties, a polyethylene host polymer with a polypropylene additive to impart propylenic functionality on the surface, polymethacrylate host polymer with a polystyrene additive to impart styrenic functionality on the surface, a polyvinyl chloride host polymer with a polystyrene additive to impart styrenic functionality on the surface, and a linear polyester host polymer with hyperbranched polyester additives.

17. The surface-modified polymer or surface-modified polymer blend according to claim 10, wherein the surface-modified polymer or surface-modified polymer blend is functionalized to provide surface paintability.

18. The surface-modified polymer or surface-modified polymer blend according to claim 17, wherein the surface-modified polymer or surface-modified polymer blend is a polystyrene host polymer with a carboxyl functionalized star additive.

19. The surface-modified polymer or surface-modified polymer blend according to claim 10, wherein the surface-modified polymer or surface-modified polymer blend is functionalized to provide scratch resistance.

20. The surface-modified polymer or surface-modified polymer blend according to claim 19, wherein the surface-modified polymer or surface-modified polymer blend is a polycarbonate host polymer with a polycarbonate star additive containing a liquid silica nanoparticle core.

21. The surface-modified polymer or surface-modified polymer blend according to claim 10, wherein the surface-modified polymer or surface-modified polymer blend is coated on a silicon surface and functionalized to increase surface wetability of the silicon surface.

22. The surface-modified polymer or surface-modified polymer blend according to claim 21, wherein the surface-modified polymer or surface-modified polymer blend is a polystyrene host polymer with poly(benzyl ether) dendrimer additives.

23. The surface-modified polymer or surface-modified polymer blend according to claim 10, wherein the surface-modified polymer or surface-modified polymer blend is an ultrafiltration membrane containing an additive functionalized to increase anti-fouling capabilities of an ultrafiltration membrane.

24. The surface-modified polymer or surface-modified polymer blend according to claim 23, wherein the surface-modified polymer or surface-modified polymer blend is an ultrafiltration membrane host polymer with a polyacrylonitrile-graft-poly (ethylene oxide) comb copolymer additive.

25. The surface-modified polymer or surface-modified polymer blend according to claim 10, wherein the surface-modified polymer or surface-modified polymer blend is functionalized to modify surface tension of said surface-modified polymer or surface-modified polymer blend.

26. The surface-modified polymer or surface-modified polymer blend according to claim 25, wherein the surface-modified polymer or surface-modified polymer blend is a linear polyester host polymer with hyperbranched polyester additives.
